(19) United States
(12) Patent Application Publication
(10) Pub. No.: US 2022/0238995 A1
(43) Pub. Date: Jul. 28, 2022

(54) RADOME AND METHOD OF DESIGNING THE SAME

(71) Applicant: SAINT-GOBAIN PERFORMANCE PLASTICS CORPORATION, Solon, OH (US)

(72) Inventors: Flavien FREMY, Belmont, MA (US); Michael MONN, Cambridge, MA (US); Mackenzie SHELDON, Cambridge, MA (US); Marc BENECK, Natick, MA (US); Simon MAZOYER, Paris (FR); Emmanuel MIMOUN, Boulogne-Billancourt (FR); Nicolas MIELEC, Paris (FR)

(21) Appl. No.: 17/648,596

(22) Filed: Jan. 21, 2022

Related U.S. Application Data
(60) Provisional application No. 63/140,573, filed on Jan. 22, 2021.

(51) Int. Cl. H01Q 1/42

(52) U.S. Cl. CPC H01Q 1/421; H01Q 1/422

(57) ABSTRACT

According to a first aspect, a method of designing a radome may include defining a set number N of flight paths FP_{N}, where each flight path FP_{N} is between a first city and a second city, determining a Looking Angle Distribution (Lα-Dist) for each flight path FP_{N}, calculating a Combination Looking Angle Distribution (Combo-Lα-Dist) for the set number N of flight paths FP_{N}, determining a Combination Incidence Angle Distribution (Combo-Iα-Dist) corresponding the Combo-Lα-Dist, and tailoring at least one radome shell structural component of the radome to minimize electromagnetic degradation of electromagnetic waves intersecting the radome at angles within the Combo-Iα-Dist.

### CROSS-REFERENCE TO RELATED APPLICATION(S)

This application claims priority under 37 U.S.C. § 119(e) to U.S. Provisional Patent Application No. 63/140,573, entitled “RADOME AND METHOD OF DESIGNING THE SAME,” by Flavien FREMY et al., filed Jan. 22, 2021, which is assigned to the current assignee hereof and incorporated herein by reference in its entirety.

### FIELD OF THE DISCLOSURE

The present disclosure relates to a method of designing a radome structure and the corresponding radome structure, and more particularly to a method of designing a radome structure and the corresponding radome structure tailored a specific flight path or to specific flight paths.

### BACKGROUND

Generally, radar and/or communications antennas are covered with radomes to protect the antennas from harmful weather conditions and to ensure the antennas continuous and precise operation. Radomes can be in the form of thin wall radomes, solid wall radomes, and sandwich radomes. Thin wall radomes have a thickness typically less than 2 mm and may be supported using increased air pressure or using a supporting frame. Solid wall radomes are typically made of a heavier solid laminate, and sandwich radomes include a low dielectric core material sandwiched between thin inner and outer laminate layers. The core material is typically a plastic foam structure or a honeycomb structure.

Regardless of the materials used to form radomes, the walls generally degrade the signal strength of electromagnetic waves transmitted from the antennas through the radome. While the structure of radomes is often designed to minimize such degradation, they are only optimized to work with electromagnetic waves traveling through the radomes at certain angle of incidence ranges. However, since some radome shapes vary depending on desired mechanical and aerodynamic properties, the angle of incidence of the electromagnetic waves traveling through the radome also varies depending on the location on the shell where the waves travel through. Also, when attached to an airplane, the angle of incidence of the electromagnetic waves traveling through the radome varies depending on the flight path of the airplane relative signal origination or destination point (i.e., a satellite). Accordingly, radomes with improved designs that further minimize electromagnetic degradation caused by the radome on electromagnetic waves based on the flight path or multiple flight paths of a particular plane are desired.

### SUMMARY

According to a first aspect, a method of designing a radome may include defining a set number N of flight paths FP_{N}, where each flight path FP_{N} is between a first city and a second city, determining a Looking Angle Distribution (Lα-Dist) for each flight path FP_{N}, calculating a Combination Looking Angle Distribution (Combo-Lα-Dist) for the set number N of flight paths FP_{N}, determining a Combination Incidence Angle Distribution (Combo-Iα-Dist) corresponding the Combo-Lα-Dist, and tailoring at least one radome shell structural component of the radome to minimize electromagnetic degradation of electromagnetic waves intersecting the radome at angles within the Combo-Iα-Dist.

According to another aspect, a radome may include at least one radome shell structural component tailored to minimize electromagnetic degradation of electromagnetic waves intersecting the radome at angles within a Combination Incidence Angle Distribution (Combo-Iα-Dist). The Combo-Iα-Dist corresponds to a Combination Looking Angle Distribution (Combo-Lα-Dist). The Combo-Lα-Dist is determined by defining a set number N of flight paths FP_{N}, where each flight path FP_{N} is between a first city and a second city, determining a Looking Angle Distribution (Lα-Dist) for each flight path FP_{N}, and calculating a Combination Looking Angle Distribution (Combo-Lα-Dist) for the set number N of flight paths FP_{N}.

### BRIEF DESCRIPTION OF THE DRAWINGS

Embodiments are illustrated by way of example and are not limited to the accompanying FIGURES.

FIG. 1 includes a diagram showing a radome design method 100 according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a method of designing a radome that includes tailoring at least one radome shell structural component of a radome to minimize electromagnetic degradation of electromagnetic waves intersecting the radome at angles corresponding to a particular flight path or to a particular set of flight paths. Further embodiments described herein are also generally directed to radomes having a shell structure that is designed to minimize electromagnetic degradation caused by the shell on electromagnetic waves intersecting the radome at angles corresponding to a particular flight path or to a particular set of flight paths.

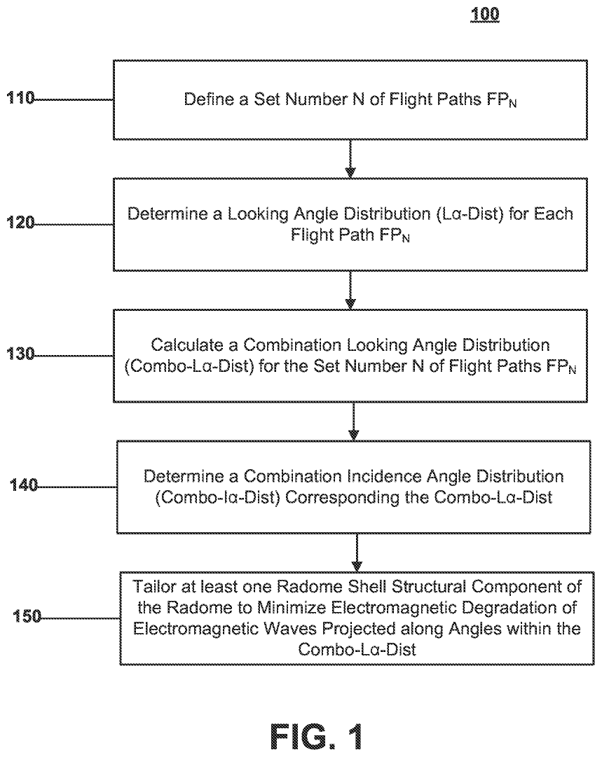

For purposes of illustration, FIG. 1 includes a diagram showing a radome design method 100 according to embodiments described herein. For purposes of embodiments described herein, a radome designed according to radome design method 100 may include a shell defining an outer structure of the radome and enclosing an antenna seating position within the radome. According to particular embodiments, the shell of the radome may include a dielectric stack. It will be appreciated that the dielectric stack may vary from a simple dielectric stack including a single dielectric layer to a complex dielectric stack including multiple dielectric layers in various configurations.

According to particular embodiments, and as shown in FIG. 1, a radome design method 100 may include a first step 110 of defining a set number N of flight paths FP_{N}, where each flight path FP_{N} is between a first city and a second city, a second step 120 of determining a Looking Angle Distribution (Lα-Dist) for each flight path FP_{N}, a third step 130 of calculating a Combination Looking Angle Distribution (Combo-Lα-Dist) for the set number N of flight paths FP_{N}, a fourth step 140 of determining a Combination Incidence Angle Distribution (Combo-Iα-Dist) corresponding the Combo-Lα-Dist, and a fifth step 150 of tailoring at least one radome shell structural component of the radome to minimize electromagnetic degradation of electromagnetic waves intersecting the radome at angles within the Combo-Iα-Dist.

Referring to the first step 110 of the radome design method 100, for purposes of embodiments described herein, defining a set number N of flight paths FP_{N} further comprises utilizing a clustering algorithm to group flight paths by a particular characteristic. According to particular embodiments, the clustering algorithm may be based on, for example, K means clustering, mean shift clustering, DBSCAN clustering, Gaussian mixtures model (GMM) clustering, hierarchical agglomerative clustering or any combination thereof. According to yet other embodiments, the characteristic by which the clustering algorithm groups flights may be selected from the group consisting of, for example, aircraft type, airlines, travel type (leisure vs. business), radome type, antennas (hardware), satellite used by a provider, flight path plane relative to equatorial plane combined with direction, geographic location, La-distribution, and flight duration.

According to certain embodiments, the set number N may be a specific number relative to the total number of flight paths currently in use worldwide. For example, where the total number of flight paths currently in use world-wide is represented by TFP, the set number N may be equal to not greater than about 0.5*TFP, such as, not greater than about 0.45*TFP or not greater than about 0.4*TFP or not greater than about 0.35*TFP or not greater than about 0.3*TFP or even not greater than about 0.25*TFP.

According to particular embodiments, the set number N may be a specific number. For example, the set number N may be at least 1 flight path, such as, at least about 2 flight paths or at least about 3 flight paths or at least about 4 flight paths or at least about 5 flight paths or at least about 6 flight paths or at least about 7 flight paths or at least about 8 flight paths or at least about 9 flight paths or at least about 10 flight paths or at least about 11 flight paths or at least about 12 flight paths or at least about 13 flight paths or at least about 14 flight paths or even at least about 15 flight paths. According to still other embodiments, the set number N may be not greater than about 29,000 flight paths, such as, not greater than about 15,000 flight paths or not greater than about 7,000 flight paths or not greater than about 3,500 flight paths or not greater than about 1,000 flight paths or not greater than about 500 flight paths or not greater than about 100 flight paths or not greater than about 50 flight paths or not greater than about 30 flight paths or not greater than about 29 flight paths or not greater than about 28 flight paths or not greater than about 27 flight paths or not greater than about 26 flight paths or not greater than about 25 flight paths or not greater than about 24 flight paths or not greater than about 23 flight paths or not greater than about 22 flight paths or not greater than about 21 flight paths or even not greater than about 20 flight paths. It will be appreciated that set number N may be between any of the minimum and maximum values noted above. It will be further appreciated that the set number N may be any number of regions within a range between any of the minimum and maximum values noted above.

Referring to the second step 120 of the radome design method 100, for purposes of embodiments described herein, a Lα-Dist may be defined as a total looking angle distribution along a particular flight path. A particular looking angle for a given radome is the direction of a signal from a satellite to an antenna within the radome or an antenna within the radome to a satellite. The total looking angle distribution for a particular flight path is equal to the accumulated looking angles between the satellite and the radome throughout the duration of a particular flight path.

Referring to the third step 130 of the radome design method 100, for purposes of embodiments described herein, a Combo-Lα-Dist may be defined as the total looking angle distribution along the set number N of flight paths FP_{N}. The total looking angle distribution along the set number N of flight paths FP_{N} is equal to the accumulated looking angles between the satellite and the radome throughout the duration of each flight path FP_{N}.

According to particular embodiments, the third step 130 of calculating a Combination Looking Angle Distribution (Combo-Lα-Dist) for the set number N of flight paths FP_{N} may further include weighting each flight path FP_{N} and using the weighted value for calculating the Combo-Lα-Dist. According to particular embodiments, weighting of each flight path may be based on a particular variable, such as, 1) distance of a given flight path relative to the other flight paths, 2) composition of leisure vs. business travel, 3) number of passengers on each flight (i.e. based on plane size), 4) use frequency of a flight path (i.e. how many times per day the flight path is traveled), 5) the number of people who buy Wi-Fi on a plane using a particular flight path.

Referring to the fifth step 150 of the radome design method 100, for purposes of embodiments described herein, tailoring at least one radome shell structural component to minimize electromagnetic degradation of electromagnetic waves intersecting the radome at angles within the Combo-Iα-Dist may particularly include tailoring an exterior shape of the radome.

According to still other embodiments, tailoring at least one radome shell structural component to minimize electromagnetic degradation of electromagnetic waves intersecting the radome at angles within the Combo-Iα-Dist may particularly include tailoring a number of structurally distinct zones that make up the radome shell structural component.

According to still other embodiments, tailoring at least one radome shell structural component to minimize electromagnetic degradation of electromagnetic waves intersecting the radome at angles within the Combo-Iα-Dist may particularly include tailoring a characteristic of at least two structurally distinct zones that make up the radome shell structural component. According to specific embodiments, the characteristic may be selected from the group consisting of: a) a shape of each distinct zone, b) a placement pattern of each distinct zone in the radome, c) a size of each distinct zone, d) a location of each distinct zone in the radome, e) a structure of each distinct zone in the radome, and f) any combination thereof.

According to yet other embodiments, tailoring at least one radome shell structural component to minimize electromagnetic degradation of electromagnetic waves intersecting the radome at angles within the Combo-Iα-Dist may particularly include tailoring a number of structurally distinct dielectric layers stacked on top of each other to make up the radome shell structural component.

According to yet other embodiments, tailoring at least one radome shell structural component to minimize electromagnetic degradation of electromagnetic waves intersecting the radome at angles within the Combo-Iα-Dist may particularly include tailoring a characteristic of at least two structurally distinct dielectric layers stacked on top of each other to make up the radome shell structural component. According to specific embodiments, the characteristic may be selected from the group consisting of: a) a thickness of each distinct dielectric layer, b) a material composition of each distinct dielectric layer, c) an order of each distinct dielectric layer, d) a “mesostructure” of each distinct dielectric layer, and e) any combination thereof.

According to particular embodiments, minimizing electromagnetic degradation of electromagnetic waves intersecting the radome at angles within the Combo-Iα-Dist may include minimizing an electromagnetic degradation selected from the group consisting of transmission loss for any incident polarization, co-polarization loss, cross-polarization loss, polarization change, boresight error, sidelobe level increase, main beam shape distortion, reflected power, noise increase, antenna VSWR increase or combinations thereof.

According to particular embodiments described herein, minimizing transmission loss for any incident polarization may include tailoring at least one radome shell structural component to minimize the transmission loss of electromagnetic waves intersecting the radome at angles within the Combo-Iα-Dist. For purposes of embodiments described herein, transmission loss for an incident polarization is defined as a percent change from a measured baseline transmission for an incident polarization and may be measured using RTCA/DO-213.

According to particular embodiments described herein, the at least one radome shell structural component may be designed to minimize transmission loss to a particular level. For example, the at least one radome shell structural component may be designed to minimize transmission loss to not greater than about −0.1 dB, such as, not greater than about −0.2 dB or not greater than about −0.3 dB or not greater than about −0.4 dB or not greater than about −0.5 dB or not greater than about −1.0 dB or not greater than about −1.5 dB or not greater than about −2.0 dB or not greater than about −2.5 dB or not greater than about −3.0 dB or not greater than about −3.5 dB or not greater than about −4.0 dB or not greater than about −4.5 dB or even not greater than about −5.0 dB.

According to other embodiments described herein, minimizing co-polarization loss may include tailoring at least one radome shell structural component to minimize the co-polarization loss of electromagnetic waves intersecting the radome at angles within the Combo-Iα-Dist. For purposes of embodiments described herein, co-polarization loss is defined as the transmission loss measured when the reception antenna is showing the same nominal polarization as the transmitting antenna and may be measured using RTCA/DO-213.

According to particular embodiments described herein, the at least one radome shell structural component may be designed to minimize co-polarization loss to a particular level. For example, the at least one radome shell structural component may be designed to minimize co-polarization loss to at least about −5.0 dB, such as, at least about −4.5 dB or at least about −4.0 dB or at least about −4.0 dB or at least about −3.5 dB or at least about −3.0 dB or at least about −2.5 dB or at least about −2.0 dB or at least about −1.5 dB or at least about −1.0 dB or at least about −0.5 dB or at least about −0.4 dB or at least about −0.3 dB or at least about −0.2 dB or even at least about −0.1 dB.

According to other embodiments described herein, maximize cross-polarization loss may include tailoring at least one radome shell structural component to maximize the cross-polarization loss of electromagnetic waves intersecting the radome at angles within the Combo-Iα-Dist. For purposes of embodiments described herein, cross-polarization loss is defined as the transmission loss measured when the reception antenna is showing a polarization orthogonal to the nominal polarization of the transmitting antenna and may be measured using RTCA/DO-213.

According to particular embodiments described herein, the at least one radome shell structural component may be designed to maximize cross-polarization loss to a particular level. For example, the at least one radome shell structural component may be designed to maximize cross-polarization loss to not greater than about −10 dB, such as, not greater than about −20 dB or not greater than about −30 dB or not greater than about −40 dB or not greater than about −50 dB or not greater than about −60 dB or not greater than about −70 dB or not greater than about −80 dB or not greater than about −90 dB or even not greater than about −100 dB.

According to other embodiments described herein, minimizing polarization change may include tailoring at least one radome shell structural component to minimize polarization change of electromagnetic waves intersecting the radome at angles within the Combo-Iα-Dist. For purposes of embodiments described herein, polarization change is defined as the co-polarization loss due to a modification of the initial polarization and may be measured using RTCA DO-213.

According to particular embodiments described herein, the at least one radome shell structural component may be designed to minimize polarization change to a particular level. For example, the at least one radome shell structural component may be designed to minimize polarization change to at least about −100 dB, such as, at least about −90 dB or at least about −80 dB or at least about −70 dB or at least about −60 dB or at least about −50 dB or at least about −40 dB or at least about −30 dB or at least about −20 dB or even at least about −10 dB.

According to other embodiments described herein, minimizing boresight error may include tailoring at least one radome shell structural component to minimize boresight error of electromagnetic waves intersecting the radome at angles within the Combo-Iα-Dist. For purposes of embodiments described herein, boresight error is defined as the angular discrepancy between the angle of the initial antenna far profile maximum in terms of elevation and azimuth and the angle of the far field profile maximum after crossing the radome and may be measured using RTCA DO-213.

According to particular embodiments described herein, the at least one radome shell structural component may be designed to minimize boresight error to a particular level. For example, a structural region of the shell of the radome may be designed to minimize boresight error to not greater than about 20 mrad, such as, not greater than about 18 mrad or not greater than about 16 mrad or not greater than about 14 mrad or not greater than about 12 mrad or not greater than about 10 mrad or not greater than about 8 mrad or not greater than about 6 mrad or not greater than about 4 mrad or not greater than about 2 mrad or not greater than about 1 mrad or not greater than about 0.9 mrad or not greater than about 0.8 mrad or not greater than about 0.7 mrad or not greater than about 0.6 mrad or not greater than about 0.5 mrad or not greater than about 0.4 mrad or not greater than about 0.3 mrad or not greater than about 0.2 mrad or not greater than about 0.1 mrad.

According to other embodiments described herein, minimizing sidelobe level increase for any incident polarization may include tailoring at least one radome shell structural component to minimize sidelobe level of electromagnetic waves intersecting the radome at angles within the Combo-Iα-Dist. For purposes of embodiments described herein, sidelobe level increase is defined as the difference between the level of the sidelobes in the antenna pattern and the level of the sidelobes after crossing the radome and may be measures using RTCA DO-213.

According to particular embodiments described herein, the at least one radome shell structural component may be designed to increase sidelobe level to a particular level. For example, the at least one radome shell structural component may be designed to increase sidelobe level to not greater than about 10 dB, such as, not greater than about 9 dB or not greater than about 8 dB or not greater than about 7 dB or not greater than about 6 dB or not greater than about 5 dB or not greater than about 4 dB or not greater than about 3 dB or not greater than about 2 dB or not greater than about 1 dB or not greater than about 0.9 dB or not greater than about 0.8 dB or not greater than about 0.7 dB or not greater than about 0.6 dB or not greater than about 0.5 dB or not greater than about 0.4 dB or not greater than about 0.3 dB or not greater than about 0.2 dB or not greater than about 0.1 dB.

According to other embodiments described herein, minimizing main beam shape distortion may include tailoring at least one radome shell structural component to minimize main beam shape distortion of electromagnetic waves intersecting the radome at angles within the Combo-Iα-Dist. For purposes of embodiments described herein, main beam shape distortion is defined as pattern distortion and may be measured using RTCA DO-213.

According to particular embodiments described herein, the at least one radome shell structural component may be designed to minimize main beam shape distortion to a particular level. For example, the at least one radome shell structural component may be designed to minimize main beam shape distortion to not greater than about 5%, such as, not greater than about 4.5% or not greater than about 4.0% or not greater than about 3.5% or not greater than about 3.0% or not greater than about 2.5% or not greater than about 2.0% or not greater than about 1.5% or not greater than about 1.0% or not greater than about 0.9% or not greater than about 0.8% or not greater than about 0.7% or not greater than about 0.6% or not greater than about 0.5% or not greater than about 0.4% or not greater than about 0.3% or not greater than about 0.2% or not greater than about 0.1%.

According to other embodiments described herein, minimizing reflected power may include tailoring at least one radome shell structural component to minimize reflected power electromagnetic waves intersecting the radome at angles within the Combo-Iα-Dist. For purposes of embodiments described herein, reflected power is defined as the change in the magnitude of the reflection coefficient at the port of the radar and/or communications antenna which is caused by the presence of the radome. This is measured using a reflectometer with a remote head.

According to particular embodiments described herein, the at least one radome shell structural component may be designed to minimize reflected power to a particular level. For example, the at least one radome shell structural component may be designed to minimize reflected power to not greater than about −0.1 dB, such as, not greater than about −0.2 dB or not greater than about −0.3 dB or not greater than about −0.4 dB or not greater than about −0.5 dB or not greater than about −1.0 dB or not greater than about −1.5 dB or not greater than about −2.0 dB or not greater than about −2.5 dB or not greater than about −3.0 dB or not greater than about −3.5 dB or not greater than about −4.0 dB or not greater than about −4.5 dB or even not greater than about −5.0 dB.

Referring now to a radome designed and formed according to embodiments described herein, such a radome may include at least one radome shell structural component tailored to minimize electromagnetic degradation of electromagnetic waves intersecting the radome at angles within a Combination Incidence Angle Distribution (Combo-Iα-Dist). According to particular embodiments, the Combo-Iα-Dist corresponds to a Combination Looking Angle Distribution (Combo-Lα-Dist). For purposes embodiments described herein, the Combo-Lα-Dist is determined by defining a set number N of flight paths FP_{N}, where each flight path FP_{N} is between a first city and a second city, determining a Looking Angle Distribution (Lα-Dist) for each flight path FP_{N}, and calculating a Combination Looking Angle Distribution (Combo-Lα-Dist) for the set number N of flight paths FP_{N}.

According to certain embodiments, the set number N may be a specific number relative to the total number of flight paths currently in use world wide. For example, where the total number of flight paths currently in use world-wide is represented by TFP, the set number N may be equal to not greater than about 0.5*TFP, such as, not greater than about 0.45*TFP or not greater than about 0.4*TFP or not greater than about 0.35*TFP or not greater than about 0.3*TFP or even not greater than about 0.25*TFP.

According to certain embodiments, the set number N may be a specific number. For example, the set number N may be at least 1 flight path, such as, at least about 2 flight paths or at least about 3 flight paths or at least about 4 flight paths or at least about 5 flight paths or at least about 6 flight paths or at least about 7 flight paths or at least about 8 flight paths or at least about 9 flight paths or at least about 10 flight paths or at least about 11 flight paths or at least about 12 flight paths or at least about 13 flight paths or at least about 14 flight paths or even at least about 15 flight paths. According to still other embodiments, the set number N may be not greater than about 29,000 flight paths, such as, not greater than about 15,000 flight paths or not greater than about 7,000 flight paths or not greater than about 3,500 flight paths or not greater than about 1,000 flight paths or not greater than about 500 flight paths or not greater than about 100 flight paths or not greater than about 50 flight paths or not greater than about 30 flight paths or not greater than about 29 flight paths or not greater than about 28 flight paths or not greater than about 27 flight paths or not greater than about 26 flight paths or not greater than about 25 flight paths or not greater than about 24 flight paths or not greater than about 23 flight paths or not greater than about 22 flight paths or not greater than about 21 flight paths or even not greater than about 20 flight paths. It will be appreciated that set number N may be between any of the minimum and maximum values noted above. It will be further appreciated that the set number N may be any number of regions within a range between any of the minimum and maximum values noted above.

According to yet other embodiments, defining the set number N of flight paths FP_{N} may further include utilizing a clustering algorithm to group flight paths by a particular characteristic. According to particular embodiments, the clustering algorithm may be based on, for example, K means clustering, mean shift clustering, DBSCAN clustering, Gaussian mixtures model (GMM) clustering, hierarchical agglomerative clustering or any combination thereof. According to yet other embodiments, the characteristic by which the clustering algorithm groups flights may be selected from the group consisting of, for example, aircraft type, airlines, travel type (leisure vs. business), radome type, antennas (hardware), satellite used by a provider, flight path plane relative to equatorial plane combined with direction, geographic location, La-distribution, and flight duration.

According to still other embodiments, calculating a Combination Looking Angle Distribution (Combo-Lα-Dist) for the set number N of flight paths FP_{N} may further include weighting each flight path FP_{N} and using the weighted value for calculating the Combo-Lα-Dist. According to particular embodiments, weighting of each flight path may be based on a particular variable, such as, 1) distance of a given flight path relative to the other flight paths, 2) composition of leisure vs. business travel, 3) number of passengers on each flight (i.e. based on plane size), 4) use frequency of a flight path (i.e. how many times per day the flight path is traveled), 5) the number of people who buy Wi-Fi on a plane using a particular flight path.

According to certain embodiments, the at least one radome shell structural component may be tailored to minimize electromagnetic degradation of electromagnetic waves intersecting the radome at angles within the Combo-Iα-Dist may particularly include tailoring an exterior shape of the radome.

According to still other embodiments, the at least one radome shell structural component may be tailored to minimize electromagnetic degradation of electromagnetic waves intersecting the radome at angles within the Combo-Iα-Dist may particularly include tailoring a number of structurally distinct zones that make up the radome shell structural component.

According to still other embodiments, the at least one radome shell structural component may be tailored to minimize electromagnetic degradation of electromagnetic waves intersecting the radome at angles within the Combo-Iα-Dist may particularly include tailoring a characteristic of at least two structurally distinct zones that make up the radome shell structural component. According to specific embodiments, the characteristic may be selected from the group consisting of: a) a shape of each distinct zone, b) a placement pattern of each distinct zone in the radome, c) a size of each distinct zone, d) a location of each distinct zone in the radome, e) a structure of each distinct zone in the radome, and f) any combination thereof.

According to yet other embodiments, the at least one radome shell structural component may be tailored to minimize electromagnetic degradation of electromagnetic waves intersecting the radome at angles within the Combo-Iα-Dist may particularly include tailoring a number of structurally distinct dielectric layers stacked on top of each other to make up the radome shell structural component.

According to yet other embodiments, the at least one radome shell structural component may be tailored to minimize electromagnetic degradation of electromagnetic waves intersecting the radome at angles within the Combo-Iα-Dist by tailoring a characteristic of at least two structurally distinct dielectric layers stacked on top of each other to make up the radome shell structural component. According to specific embodiments, the characteristic may be selected from the group consisting of: a) a thickness of each distinct dielectric layer, b) a material composition of each distinct dielectric layer, c) an order of each distinct dielectric layer, d) a “mesostructure” of each distinct dielectric layer, and e) any combination thereof.

According to particular embodiments, the electromagnetic degradation of electromagnetic waves intersecting the radome at angles within the Combo-Iα-Dist may be minimized by minimizing an electromagnetic degradation selected from the group consisting of transmission loss for any incident polarization, co-polarization loss, cross-polarization loss, polarization change, boresight error, sidelobe level increase, main beam shape distortion, reflected power, noise increase, antenna VSWR increase or combinations thereof.

According to particular embodiments described herein, the radome may include at least one radome shell structural component tailored to minimize the transmission loss of electromagnetic waves intersecting the radome at angles within the Combo-Iα-Dist. For purposes of embodiments described herein, transmission loss for an incident polarization is defined as a percent change from a measured baseline transmission for an incident polarization and may be measured using RTCA/DO-213.

According to particular embodiments described herein, the at least one radome shell structural component may be designed to minimize transmission loss to a particular level. For example, the at least one radome shell structural component may be designed to minimize transmission loss to not greater than about −0.1 dB, such as, not greater than about −0.2 dB or not greater than about −0.3 dB or not greater than about −0.4 dB or not greater than about −0.5 dB or not greater than about −1.0 dB or not greater than about −1.5 dB or not greater than about −2.0 dB or not greater than about −2.5 dB or not greater than about −3.0 dB or not greater than about −3.5 dB or not greater than about −4.0 dB or not greater than about −4.5 dB or even not greater than about −5.0 dB.

According to other embodiments described herein, the radome may include at least one radome shell structural component tailored to minimize the co-polarization loss of electromagnetic waves intersecting the radome at angles within the Combo-Iα-Dist. For purposes of embodiments described herein, co-polarization loss is defined as the transmission loss measured when the reception antenna is showing the same nominal polarization as the transmitting antenna and may be measured using RTCA/DO-213.

According to particular embodiments described herein, the at least one radome shell structural component may be designed to minimize co-polarization loss to a particular level. For example, the at least one radome shell structural component may be designed to minimize co-polarization loss to at least about −5.0 dB, such as, at least about −4.5 dB or at least about −4.0 dB or at least about −4.0 dB or at least about −3.5 dB or at least about −3.0 dB or at least about −2.5 dB or at least about −2.0 dB or at least about −1.5 dB or at least about −1.0 dB or at least about −0.5 dB or at least about −0.4 dB or at least about −0.3 dB or at least about −0.2 dB or even at least about −0.1 dB.

According to other embodiments described herein, the radome may include at least one radome shell structural component tailored to maximize the cross-polarization loss of electromagnetic waves intersecting the radome at angles within the Combo-Iα-Dist. For purposes of embodiments described herein, cross-polarization loss is defined as the transmission loss measured when the reception antenna is showing a polarization orthogonal to the nominal polarization of the transmitting antenna and may be measured using RTCA/DO-213.

According to particular embodiments described herein, the at least one radome shell structural component may be designed to maximize cross-polarization loss to a particular level. For example, the at least one radome shell structural component may be designed to maximize cross-polarization loss to not greater than about −10 dB, such as, not greater than about −20 dB or not greater than about −30 dB or not greater than about −40 dB or not greater than about −50 dB or not greater than about −60 dB or not greater than about −70 dB or not greater than about −80 dB or not greater than about −90 dB or even not greater than about −100 dB.

According to other embodiments described herein, the radome may include at least one radome shell structural component tailored to minimize polarization change of electromagnetic waves intersecting the radome at angles within the Combo-Iα-Dist. For purposes of embodiments described herein, polarization change is defined as the co-polarization loss due to a modification of the initial polarization and may be measured using RTCA DO-213.

According to particular embodiments described herein, the at least one radome shell structural component may be designed to minimize polarization change to a particular level. For example, the at least one radome shell structural component may be designed to minimize polarization change to at least about −100 dB, such as, at least about −90 dB or at least about −80 dB or at least about −70 dB or at least about −60 dB or at least about −50 dB or at least about −40 dB or at least about −30 dB or at least about −20 dB or even at least about −10 dB.

According to other embodiments described herein, the radome may include at least one radome shell structural component tailored to minimize boresight error of electromagnetic waves intersecting the radome at angles within the Combo-Iα-Dist. For purposes of embodiments described herein, boresight error is defined as the angular discrepancy between the angle of the initial antenna far profile maximum in terms of elevation and azimuth and the angle of the far field profile maximum after crossing the radome and may be measured using RTCA DO-213.

According to particular embodiments described herein, the at least one radome shell structural component may be designed to minimize boresight error to a particular level. For example, the at least one structural region of the shell of the radome may be designed to minimize boresight error to not greater than about 20 mrad, such as, not greater than about 18 mrad or not greater than about 16 mrad or not greater than about 14 mrad or not greater than about 12 mrad or not greater than about 10 mrad or not greater than about 8 mrad or not greater than about 6 mrad or not greater than about 4 mrad or not greater than about 2 mrad or not greater than about 1 mrad or not greater than about 0.9 mrad or not greater than about 0.8 mrad or not greater than about 0.7 mrad or not greater than about 0.6 mrad or not greater than about 0.5 mrad or not greater than about 0.4 mrad or not greater than about 0.3 mrad or not greater than about 0.2 mrad or not greater than about 0.1 mrad.

According to other embodiments described herein, the radome may include at least one radome shell structural component tailored to minimize sidelobe level of electromagnetic waves intersecting the radome at angles within the Combo-Iα-Dist. For purposes of embodiments described herein, sidelobe level increase is defined as the difference between the level of the sidelobes in the antenna pattern and the level of the sidelobes after crossing the radome and may be measures using RTCA DO-213.

According to particular embodiments described herein, the at least one radome shell structural component may be designed to increase sidelobe level to a particular level. For example, the at least one radome shell structural component may be designed to increase sidelobe level to not greater than about 10 dB, such as, not greater than about 9 dB or not greater than about 8 dB or not greater than about 7 dB or not greater than about 6 dB or not greater than about 5 dB or not greater than about 4 dB or not greater than about 3 dB or not greater than about 2 dB or not greater than about 1 dB or not greater than about 0.9 dB or not greater than about 0.8 dB or not greater than about 0.7 dB or not greater than about 0.6 dB or not greater than about 0.5 dB or not greater than about 0.4 dB or not greater than about 0.3 dB or not greater than about 0.2 dB or not greater than about 0.1 dB.

According to other embodiments described herein, the radome may include at least one radome shell structural component tailored to minimize main beam shape distortion of electromagnetic waves intersecting the radome at angles within the Combo-Iα-Dist. For purposes of embodiments described herein, main beam shape distortion is defined as pattern distortion and may be measured using RTCA DO-213.

According to particular embodiments described herein, the at least one radome shell structural component may be designed to minimize main beam shape distortion to a particular level. For example, the at least one radome shell structural component may be designed to minimize main beam shape distortion to not greater than about 5%, such as, not greater than about 4.5% or not greater than about 4.0% or not greater than about 3.5% or not greater than about 3.0% or not greater than about 2.5% or not greater than about 2.0% or not greater than about 1.5% or not greater than about 1.0% or not greater than about 0.9% or not greater than about 0.8% or not greater than about 0.7% or not greater than about 0.6% or not greater than about 0.5% or not greater than about 0.4% or not greater than about 0.3% or not greater than about 0.2% or not greater than about 0.1%.

According to other embodiments described herein, the radome may include at least one radome shell structural component structured to minimize reflected power electromagnetic waves intersecting the radome at angles within the Combo-Iα-Dist. For purposes of embodiments described herein, reflected power is defined as the change in the magnitude of the reflection coefficient at the port of the radar and/or communications antenna which is caused by the presence of the radome. This is measured using a reflectometer with a remote head.

According to particular embodiments described herein, the at least one radome shell structural component may be designed to minimize reflected power to a particular level. For example, the at least one radome shell structural component may be designed to minimize reflected power to not greater than about −0.1 dB, such as, not greater than about −0.2 dB or not greater than about −0.3 dB or not greater than about −0.4 dB or not greater than about −0.5 dB or not greater than about −1.0 dB or not greater than about −1.5 dB or not greater than about −2.0 dB or not greater than about −2.5 dB or not greater than about −3.0 dB or not greater than about −3.5 dB or not greater than about −4.0 dB or not greater than about −4.5 dB or even not greater than about −5.0 dB.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of designing a radome comprising: defining a set number N of flight paths FP_{N}, wherein each flight path FP_{N} is between a first city and a second city, determining a Looking Angle Distribution (Lα-Dist) for each flight path FP_{N}, calculating a Combination Looking Angle Distribution (Combo-Lα-Dist) for the set number N of flight paths FP_{N}, wherein the Combo-Lα-Dist, determining a Combination Incidence Angle Distribution (Combo-Iα-Dist) corresponding the Combo-Lα-Dist, and tailoring at least one radome shell structural component of the radome to minimize electromagnetic degradation of electromagnetic waves intersecting the radome at angles within the Combo-Iα-Dist.

Embodiment 2. The method of embodiment 1, wherein defining a set number N of flight paths FP_{N} further comprises utilizing a clustering algorithm to group flight paths by a particular characteristic. According to particular embodiments, the clustering algorithm may be based on, for example, K means clustering, mean shift clustering, DBSCAN clustering, Gaussian mixtures model (GMM) clustering, hierarchical agglomerative clustering or any combination thereof. According to yet other embodiments, the characteristic by which the clustering algorithm groups flights may be selected from the group consisting of, for example, aircraft type, airlines, travel type (leisure vs. business), radome type, antennas (hardware), satellite used by a provider, flight path plane relative to equatorial plane combined with direction, geographic location, La-distribution, and flight duration.

Embodiment 3. The method of embodiment 1, wherein calculating the Combo-Lα-Dist for the set number N of flight paths FP_{N} further comprises weighting each flight path FP_{N} based on 1) distance of a given flight path relative to the other flight paths, 2) composition of leisure vs. business travel, 3) number of passengers on each flight (i.e. based on plane size), 4) use frequency of a flight path (i.e. how many times per day the flight path is traveled), 5) the number of people who buy Wi-Fi on a plane using a particular flight path.

Embodiment 4. The method of embodiment 1, wherein N is equal to at least about 1 flight path or at least about 2 flight paths or at least about 3 flight paths or at least about 4 flight paths or at least about 5 flight paths or at least about 6 flight paths or at least about 7 flight paths or at least about 8 flight paths or at least about 9 flight paths or at least about 10 flight paths or at least about 11 flight paths or at least about 12 flight paths or at least about 13 flight paths or at least about 14 flight paths or even at least about 15 flight paths.

Embodiment 5. The method of embodiment 1, wherein N is equal to not greater than about 29,000 flight paths, such as, not greater than about 15,000 flight paths or not greater than about 7,000 flight paths or not greater than about 3,500 flight paths or not greater than about 1,000 flight paths or not greater than about 500 flight paths or not greater than about 100 flight paths or not greater than about 50 flight paths or not greater than about 30 flight paths or not greater than about 29 flight paths or not greater than about 28 flight paths or not greater than about 27 flight paths or not greater than about 26 flight paths or not greater than about 25 flight paths or not greater than about 24 flight paths or not greater than about 23 flight paths or not greater than about 22 flight paths or not greater than about 21 flight paths or even not greater than about 20 flight paths.

Embodiment 6. The method of embodiment 1, wherein tailoring at least one radome shell structural component to minimize electromagnetic degradation of electromagnetic waves intersecting the radome at angles within the Combo-Iα-Dist comprises tailoring an exterior shape of the radome.

Embodiment 7. The method of embodiment 1, wherein tailoring at least one radome shell structural component to minimize electromagnetic degradation of electromagnetic waves intersecting the radome at angles within the Combo-Iα-Dist comprises tailoring a number of structurally distinct zones that make up the radome shell structural component.

Embodiment 8. The method of embodiment 1, wherein tailoring at least one radome shell structural component to minimize electromagnetic degradation of electromagnetic waves intersecting the radome at angles within the Combo-Iα-Dist comprises tailoring a characteristic of at least two structurally distinct zones that make up the radome shell structural component, wherein the characteristic is selected from the group consisting of: a) a shape of each distinct zone, b) a placement pattern of each distinct zone in the radome, c) a size of each distinct zone, d) a location of each distinct zone in the radome, e) a structure of each distinct zone in the radome, and f) any combination thereof.

Embodiment 9. The method of embodiment 1, wherein tailoring at least one radome shell structural component to minimize electromagnetic degradation of electromagnetic waves intersecting the radome at angles within the Combo-Iα-Dist comprises tailoring a number of structurally distinct dielectric layers stacked on top of each other to make up the radome shell structural component.

Embodiment 10. The method of embodiment 1, wherein tailoring at least one radome shell structural component to minimize electromagnetic degradation of electromagnetic waves intersecting the radome at angles within the Combo-Iα-Dist comprises tailoring a characteristic of at least two structurally distinct dielectric layers stacked on top of each other to make up the radome shell structural component, wherein the characteristic is selected from the group consisting of: a) a thickness of each distinct dielectric layer, b) a material composition of each distinct dielectric layer, c) an order of each distinct dielectric layer, d) a “mesostructure” of each distinct dielectric layer, and e) any combination thereof.

Embodiment 11. The method of embodiment 1, wherein minimizing electromagnetic degradation of electromagnetic waves intersecting the radome at angles within the Combo-Iα-Dist comprises minimizing an electromagnetic degradation selected from the group consisting of transmission loss for any incident polarization, co-polarization loss, cross-polarization loss, polarization change, boresight error, sidelobe level increase, main beam shape distortion, reflected power, noise increase, antenna VSWR increase or combinations thereof.

Embodiment 12. The method of embodiment 11, wherein the radome comprises a transmission loss of not greater than about −0.1 dB.

Embodiment 13. The method of embodiment 11, wherein the radome comprises a co-polarization loss of at least about −5.0 dB.

Embodiment 14. The method of embodiment 11, wherein the radome comprises a cross-polarization loss of not greater than about −10 dB.

Embodiment 15. The method of embodiment 11, wherein the radome comprises a polarization change of at least about −100 dB.

Embodiment 16. The method of embodiment 11, wherein the radome comprises a boresight error of not greater than about 20 mrad.

Embodiment 17. The method of embodiment 11, wherein the radome comprises a sidelobe level increase of not greater than about 10 dB.

Embodiment 18. The method of embodiment 11, wherein the radome comprises a main beam shape distortion of not greater than about 5%.

Embodiment 19. The method of embodiment 11, wherein the radome comprises a reflected power of not greater than about −0.1 dB.

Embodiment 20. A radome comprising at least one radome shell structural component tailored to minimize electromagnetic degradation of electromagnetic waves intersecting the radome at angles within a Combination Incidence Angle Distribution (Combo-Iα-Dist), wherein the Combo-Iα-Dist corresponds to a Combination Looking Angle Distribution (Combo-Lα-Dist), wherein the Combo-Lα-Dist is determined by defining a set number N of flight paths FP_{N}, wherein each flight path FP_{N} is between a first city and a second city, determining a Looking Angle Distribution (Lα-Dist) for each flight path FP_{N}, and calculating a Combination Looking Angle Distribution (Combo-Lα-Dist) for the set number N of flight paths FP_{N}.

Embodiment 21. The radome of embodiment 20, wherein defining a set number N of flight paths FP_{N} further comprises utilizing a clustering algorithm to group flight paths by a particular characteristic. According to particular embodiments, the clustering algorithm may be based on, for example, K means clustering, mean shift clustering, DBSCAN clustering, Gaussian mixtures model (GMM) clustering, hierarchical agglomerative clustering or any combination thereof. According to yet other embodiments, the characteristic by which the clustering algorithm groups flights may be selected from the group consisting of, for example, aircraft type, airlines, travel type (leisure vs. business), radome type, antennas (hardware), satellite used by a provider, flight path plane relative to equatorial plane combined with direction, geographic location, La-distribution, and flight duration.

Embodiment 22. The radome of embodiment 20, wherein calculating the Combo-Lα-Dist for the set number N of flight paths FP_{N} further comprises weighting each flight path FP_{N} based on 1) distance of a given flight path relative to the other flight paths, 2) composition of leisure vs. business travel, 3) number of passengers on each flight (i.e. based on plane size), 4) use frequency of a flight path (i.e. how many times per day the flight path is traveled), 5) the number of people who buy Wi-Fi on a plane using a particular flight path.

Embodiment 23. The radome of embodiment 20, wherein N is equal to at least about 1 flight path or at least about 2 flight paths or at least about 3 flight paths or at least about 4 flight paths or at least about 5 flight paths or at least about 6 flight paths or at least about 7 flight paths or at least about 8 flight paths or at least about 9 flight paths or at least about 10 flight paths or at least about 11 flight paths or at least about 12 flight paths or at least about 13 flight paths or at least about 14 flight paths or even at least about 15 flight paths.

Embodiment 24. The radome of embodiment 20, wherein N is equal to not greater than about 29,000 flight paths, such as, not greater than about 15,000 flight paths or not greater than about 7,000 flight paths or not greater than about 3,500 flight paths or not greater than about 1,000 flight paths or not greater than about 500 flight paths or not greater than about 100 flight paths or not greater than about 50 flight paths or not greater than about 30 flight paths or not greater than about 29 flight paths or not greater than about 28 flight paths or not greater than about 27 flight paths or not greater than about 26 flight paths or not greater than about 25 flight paths or not greater than about 24 flight paths or not greater than about 23 flight paths or not greater than about 22 flight paths or not greater than about 21 flight paths or even not greater than about 20 flight paths.

Embodiment 25. The radome of embodiment 20, wherein the at least one radome shell structural component tailored to minimize electromagnetic degradation of electromagnetic waves intersecting the radome at angles within the Combo-Iα-Dist comprises an exterior shape of the radome.

Embodiment 26. The radome of embodiment 20, wherein the at least one radome shell structural component tailored to minimize electromagnetic degradation of electromagnetic waves intersecting the radome at angles within the Combo-Iα-Dist comprises a number of structurally distinct zones that make up the radome shell structural component.

Embodiment 27. The radome of embodiment 20, wherein the at least one radome shell structural component tailored to minimize electromagnetic degradation of electromagnetic waves intersecting the radome at angles within the Combo-Iα-Dist comprises a characteristic of at least two structurally distinct zones that make up the radome shell structural component, wherein the characteristic is selected from the group consisting of: a) a shape of each distinct zone, b) a placement pattern of each distinct zone in the radome, c) a size of each distinct zone, d) a location of each distinct zone in the radome, e) a structure of each distinct zone in the radome, and f) any combination thereof.

Embodiment 28. The radome of embodiment 20, wherein the at least one radome shell structural component tailored to minimize electromagnetic degradation of electromagnetic waves intersecting the radome at angles within the Combo-Iα-Dist comprises a number of structurally distinct dielectric layers stacked on top of each other to make up the radome shell structural component.

Embodiment 29. The radome of embodiment 20, wherein the at least one radome shell structural component tailored to minimize electromagnetic degradation of electromagnetic waves intersecting the radome at angles within the Combo-Iα-Dist comprises a characteristic of at least two structurally distinct dielectric layers stacked on top of each other to make up the radome shell structural component, wherein the characteristic is selected from the group consisting of: a) a thickness of each distinct dielectric layer, b) a material composition of each distinct dielectric layer, c) an order of each distinct dielectric layer, d) a “mesostructure” of each distinct dielectric layer, and e) any combination thereof.

Embodiment 30. The radome of embodiment 20, wherein the minimized electromagnetic degradation of electromagnetic waves intersecting the radome at angles within the Combo-Iα-Dist comprises an electromagnetic degradation selected from the group consisting of transmission loss for any incident polarization, co-polarization loss, cross-polarization loss, polarization change, boresight error, sidelobe level increase, main beam shape distortion, reflected power, noise increase, antenna VSWR increase or combinations thereof.

Embodiment 31. The radome of embodiment 30, wherein the radome comprises a transmission loss of not greater than about −0.1 dB.

Embodiment 32. The radome of embodiment 30, wherein the radome comprises a co-polarization loss of at least about −5.0 dB.

Embodiment 33. The radome of embodiment 30, wherein the radome comprises a cross-polarization loss of not greater than about −10 dB.

Embodiment 34. The radome of embodiment 30, wherein the radome comprises a polarization change of at least about −100 dB.

Embodiment 35. The radome of embodiment 30, wherein the radome comprises a boresight error of not greater than about 20 mrad.

Embodiment 36. The radome of embodiment 30, wherein the radome comprises a sidelobe level increase of not greater than about 10 dB.

Embodiment 37. The radome of embodiment 30, wherein the radome comprises a main beam shape distortion of not greater than about 5%.

Embodiment 38. The radome of embodiment 30, wherein the radome comprises a reflected power of not greater than about −0.1 dB.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A method of designing a radome comprising:
defining a set number N of flight paths FP_{N}, wherein each flight path FP_{N} is between a first city and a second city,
determining a Looking Angle Distribution (Lα-Dist) for each flight path FP_{N},
calculating a Combination Looking Angle Distribution (Combo-Lα-Dist) for the set number N of flight paths FP_{N}
determining a Combination Incidence Angle Distribution (Combo-Iα-Dist) corresponding to the Combo-Lα-Dist, and
tailoring at least one radome shell structural component of the radome to minimize electromagnetic degradation of electromagnetic waves intersecting the radome at angles within the Combo-Iα-Dist.

2. The method of claim 1, wherein defining a set number N of flight paths FP_{N} further comprises utilizing a clustering algorithm to group flight paths by a characteristic.

3. The method of claim 1, wherein calculating the Combo-Lα-Dist for the set number N of flight paths FP_{N} further comprises weighting each flight path FP_{N} based on 1) distance of a given flight path relative to the other flight paths, 2) composition of leisure vs. business travel, 3) number of passengers on each flight (i.e. based on plane size), 4) use frequency of a flight path (i.e. how many times per day the flight path is traveled), 5) the number of people who buy Wi-Fi on a plane using a particular flight path.

4. The method of claim 1, wherein N is equal to at least about 1 flight path or at least about 2 flight paths or at least about 3 flight paths or at least about 4 flight paths or at least about 5 flight paths or at least about 6 flight paths or at least about 7 flight paths or at least about 8 flight paths or at least about 9 flight paths or at least about 10 flight paths or at least about 11 flight paths or at least about 12 flight paths or at least about 13 flight paths or at least about 14 flight paths or even at least about 15 flight paths.

5. The method of claim 1, wherein N is equal to not greater than about 29,000 flight paths, such as, not greater than about 15,000 flight paths or not greater than about 7,000 flight paths or not greater than about 3,500 flight paths or not greater than about 1,000 flight paths or not greater than about 500 flight paths or not greater than about 100 flight paths or not greater than about 50 flight paths or not greater than about 30 flight paths or not greater than about 29 flight paths or not greater than about 28 flight paths or not greater than about 27 flight paths or not greater than about 26 flight paths or not greater than about 25 flight paths or not greater than about 24 flight paths or not greater than about 23 flight paths or not greater than about 22 flight paths or not greater than about 21 flight paths or even not greater than about 20 flight paths.

6. The method of claim 1, wherein tailoring at least one radome shell structural component to minimize electromagnetic degradation of electromagnetic waves intersecting the radome at angles within the Combo-Iα-Dist comprises tailoring an exterior shape of the radome.

7. The method of claim 1, wherein tailoring at least one radome shell structural component to minimize electromagnetic degradation of electromagnetic waves intersecting the radome at angles within the Combo-Iα-Dist comprises tailoring a number of structurally distinct zones that make up the radome shell structural component.

8. The method of claim 1, wherein tailoring at least one radome shell structural component to minimize electromagnetic degradation of electromagnetic waves intersecting the radome at angles within the Combo-Iα-Dist comprises tailoring a characteristic of at least two structurally distinct zones that make up the radome shell structural component, wherein the characteristic is selected from the group consisting of:
a) a shape of each distinct zone,
b) a placement pattern of each distinct zone in the radome,
c) a size of each distinct zone,
d) a location of each distinct zone in the radome,
e) a structure of each distinct zone in the radome, and
f) any combination thereof.

9. The method of claim 1, wherein tailoring at least one radome shell structural component to minimize electromagnetic degradation of electromagnetic waves intersecting the radome at angles within the Combo-Iα-Dist comprises tailoring a number of structurally distinct dielectric layers stacked on top of each other to make up the radome shell structural component.

10. The method of claim 1, wherein tailoring at least one radome shell structural component to minimize electromagnetic degradation of electromagnetic waves intersecting the radome at angles within the Combo-Iα-Dist comprises tailoring a characteristic of at least two structurally distinct dielectric layers stacked on top of each other to make up the radome shell structural component, wherein the characteristic is selected from the group consisting of:
(a) a thickness of each distinct dielectric layer,
(b) a material composition of each distinct dielectric layer,
(c) an order of each distinct dielectric layer,
(d) a “mesostructure” of each distinct dielectric layer, and
(e) any combination thereof.

11. The method of claim 1, wherein minimizing electromagnetic degradation of electromagnetic waves intersecting the radome at angles within the Combo-Iα-Dist comprises minimizing an electromagnetic degradation selected from the group consisting of transmission loss for any incident polarization, co-polarization loss, cross-polarization loss, polarization change, boresight error, sidelobe level increase, main beam shape distortion, reflected power, noise increase, antenna VSWR increase or combinations thereof.

12. The method of claim 11, wherein the radome comprises a transmission loss of not greater than about −0.1 dB.

13. The method of claim 11, wherein the radome comprises a co-polarization loss of at least about −5.0 dB.

14. The method of claim 11, wherein the radome comprises a cross-polarization loss of not greater than about −10 dB.

15. The method of claim 11, wherein the radome comprises a polarization change of at least about −100 dB.

16. The method of claim 11, wherein the radome comprises a boresight error of not greater than about 20 mrad.

17. The method of claim 11, wherein the radome comprises a sidelobe level increase of not greater than about 10 dB.

18. The method of claim 11, wherein the radome comprises a main beam shape distortion of not greater than about 5%.

19. The method of claim 11, wherein the radome comprises a reflected power of not greater than about −0.1 dB.

20. A radome comprising at least one radome shell structural component tailored to minimize electromagnetic degradation of electromagnetic waves intersecting the radome at angles within a Combination Incidence Angle Distribution (Combo-Iα-Dist),
wherein the Combo-Iα-Dist corresponds to a Combination Looking Angle Distribution (Combo-Lα-Dist).
wherein the Combo-Lα-Dist is determined by defining a set number N of flight paths FP_{N}, wherein each flight path FP_{N} is between a first city and a second city, determining a Looking Angle Distribution (Lα-Dist) for each flight path FP_{N}, and calculating a Combination Looking Angle Distribution (Combo-Lα-Dist) for the set number N of flight paths FP_{N}.
